(19) United States
(12) Patent Application Publication
(10) Pub. No.: US 2015/0213281 A1
(43) Pub. Date: Jul. 30, 2015

(54) METHOD OF CONFIGURING PERMISSION FOR SHARING DATA AND TOUCH LINK ELECTRONIC DEVICE UTILIZING THE SAME

(71) Applicant: MediaTek Singapore Pte. Ltd., Singapore (SG)

(72) Inventors: MI TANG, Beijing (CN); HEYAN CAO, Tianjin (CN); Wan-Chun LIAO, Taipei City (TW)

(21) Appl. No.: 14/608,607

(22) Filed: Jan. 29, 2015

(30) Foreign Application Priority Data
Jan. 30, 2014 (CN) 201410044211.5

(51) Int. Cl. G06F 21/60; G06F 3/14; G09G 5/12; G06F 3/041

(52) U.S. Cl. CPC G06F 21/606; G06F 3/041; G06F 3/1423; G09G 5/12; G09G 2370/16; G09G 2370/22

(57) ABSTRACT

A method of configuring permission for sharing data and touch link electronic device utilizing the same are described. The method, configuring permission for sharing data, adopted by a first touch link electronic device, the method including: establishing, by a touch panel of the first touch link electronic device, a first communication channel to a second touch link electronic device; transmitting the permission to the second touch link electronic device via the first communication channel, wherein the permission corresponds to the shared data; and transmitting the shared data to the second touch link electronic device.

### CROSS REFERENCE TO RELATED APPLICATIONS

This application claims priority of China Patent Application No. 201410044211.5, filed on Jan. 30, 2014, the contents of which is incorporated by reference herein.

### BACKGROUND OF THE INVENTION

1. Field of the Invention

The present invention relates to a method of configuring permission for sharing data, and in particular to a method of configuring permission for sharing data and a touch link electronic device utilizing the same.

2. Description of the Related Art

Near Field Communication (NFC) is a contactless technology for identification and interconnection. Near Field Communication allows users to exchange the information, access contact and services by using the near electric field magnetic communication (such as the near electric field magnetic communication of 13.56 MHz) between the mobile devices, consumer electronics, PCs or smart electronic devices.

Due to the maturity of the market, the mobile phone with NFC can either support the function of the mobile payment or serve as a point of sale (POS). However, the proximity card reader or other similar elements must be added to the handheld device due to the NFC is operated by sending and receiving magnetic field signalssignal, which will make the size of the handheld device becomes larger, and the layout and the elements of the handheld device might be limited.

A touch link technology of the touch panel device which uses the existing panel and driver IC for communication has been developed recently, and has been described in US 2011/0304583, US 2013/0147760, CN 102916729A. The touch panel device includes a touch sensor. At least a part of the touch sensor includes at least a part of touch panel of the touch panel device. The touch panel can be the touch panel without a display function, such as the touch pad, or with the display function, such as the touch screen. The touch sensor includes the driving electrodes and the sensing electrodes set on the board for forming the capacitor structure. At least one of the driving electrodes and the sensing electrodes is used as the sending electrode, and at least one of the driving electrodes and the sensing electrodes is used as the receiving electrode. Thus, the signal can be sent and received by the existing electrodes and driver IC of the touch panel device so as to achieve the touch linkaccording to the electric field without additional proximity card reader or other similar elements, thus reducing the size and the cost of the touch panel device.

FIG. 1 is a schematic diagram of touch transmissions between a first touch panel device 101 and a second touch panel 102 device according to the related art. As shown in FIG. 1, there are near electric fields 103a and 103b between the first touch panel device 101 and the second touch panel device 102. It should be noted that each of the first touch panel device 101 and the second touch panel device 102 can have the functionalities of transmitting and receiving signals. when the first touch panel device 101 transmits signals toward the second touch panel device 102, the communications medium used by the first touch panel device 101 is the electric field portion whose electric field direction is pointing toward the second touch panel device 102 (the near electric field 103a as shown in FIG. 1). In addition, when the second touch panel device 102 transmits signals toward the first touch panel device 101, the communications medium used by the second touch panel device 102 is the electric field portion whose electric field direction is pointing toward the first touch panel device 101 (the near electric field 103ba as shown in FIG. 1). The X channel and the Y channel shown in FIG. 1 may represent the sending electrodes and the receiving electrodes set on the board for forming the capacitor structure.

FIG. 2 is a logical block diagram of a touch communications system for achieving the touch linksystem between the first touch panel device 101 and the second touch panel device 102 in accordance with the prior art. The first touch panel device includes a message transmission system 201 shown in FIG. 2, and the second touch panel device includes a message reception system 202 shown in FIG. 2. The message transmission system 201 includes a touch linkrequest signal generating unit 211, a communication connection establishing unit 212 and a first communication unit 213. The touch link request signal generating unit 211 may be arranged to generate a touch link request signal for sending touch link to the second touch panel 102 through the sending electrode. The communication connection establishing unit 212 establishes a communication connection with the second touch panel device 102 after the receiving electrodes receives a response signal from the second touch panel device 102. The first communication unit 213 sends the communication information or the data to the second touch panel device 102 through the sending electrodes after the communication connection is established.

The message reception system 202 includes a touch link request acknowledging unit 221, a communication connection establishing unit 222 and a second communication unit 223. The touch link request acknowledging unit 221 responds an acknowledge signal to the first touch panel device 101 through the sending electrodes after the receiving electrodes receive a touch link request signal sent from the first touch panel device 101. The communication connection establishing unit 222 establishes the communication connection with the first touch panel device 101 after the touch link request touch link request acknowledging unit 221 responses the acknowledge signal to the first touch panel device 101. The second communication unit 223 receives the communication information or the data sent from the first touch panel device 101 through the receiving electrodes after the communication connection is established.

FIG. 3 illustrates a first touch panel 301 of the first touch panel device 101 shown in FIG. 1 and a second touch panel 302 of the second touch panel device 102 shown in FIG. 1 according to the related art. As shown in FIG. 3, each touch panel of the first touch panel 301 and the second touch panel 302 may comprise a touch sensor (not completely shown in FIG. 3). For example, the touch sensor of the first touch panel 301 may comprise a set of transmitting electrodes installed on at least one substrate of the first touch panel 301 (e.g. the transmitting electrode 311) for transmitting signals, and may comprise a set of receiving electrodes installed on at least one substrate of the first touch panel 301 (e.g. the receiving electrode 312) for receiving signals. In another example, the touch sensor of the second touch panel 302 may comprise a set of transmitting electrodes installed on at least one substrate of the second touch panel 302 (e.g. the transmitting electrode 321) for transmitting signals, and may comprise a set of receiving electrodes installed on at least one substrate of the second touch panel 302 (e.g. the receiving electrode 322) for receiving signals.

FIG. 4 is a flow chart of the touch link method in accordance with the prior art. First, in step S401, the touch link request signal generating unit 211 generates a touch link request signal, and sends to the second touch panel device 102 through the sending electrodes. Then the receiving electrodes receive the acknowledge signal responded from the second touch panel device 102 (step S402). After that, the communication connection establishing unit 212 establishes the communication connection with the second touch panel device 102 (step S403). Finally, the method goes to the step S404, the first communication unit 213 sends the communication information or the data to the second touch panel device 102 through the sending electrodes. the first touch panel 301 and the second touch panel 302 further include a touch sensor (not fully shown in FIG. 3). The touch sensor includes the sending electrodes 311, 321 and the receiving electrodes 312, 322 disposed on the board for forming the capacitor structure. The sending electrodes 311, 321 are arranged to send the signal, and the receiving electrodes 312, 322 are arranged to receive the signal.

After a touch connection is established, a security mechanism is required to manage shared data when one of the touch link electronic devices wishes to share filefiles with another.

### BRIEF SUMMARY OF THE INVENTION

A detailed description is given in the following embodiments with reference to the accompanying drawings.

An embodiment of a method is described, configuring permission for sharing data, adopted by a first touch link electronic device, the method comprising: establishing, by a touch panel of the first touch link electronic device, a first communication channel to a second touch link electronic device; transmitting the permission to the second touch link electronic device via the first communication channel, wherein the permission corresponds to the shared data; and transmitting the shared data to the second touch link electronic device.

Another embodiment of a method is disclosed, configuring permission for sharing data, adopted by a first touch link electronic device, the method comprising: establishing, by a touch panel of the first touch link electronic device, a first communication channel to a second touch link electronic device; receiving a first permission from the second touch link electronic device via the first communication channel, wherein the first permission corresponds to the shared data transmitted by the second touch link electronic device; and receiving the shared data.

An embodiment of a first touch link electronic device is described, comprising a touch panel and a touch link module. The touch link module is configured to establish a first communication channel to a second touch link electronic device, and transmit a permission to the second touch link electronic device via the first communication channel. The permission corresponds to the data sharing withthe second touch link electronic device to provide the shared data with a property assigned by the permission in the second touch link electronic device.

An embodiment of a first touch link electronic device is described, comprising a touch panel and a touch link module. The touch link module is configured to establish a first communication channel to a second touch link electronic device, and receive a permission from the second touch link electronic device via the first communication channel. The permission corresponds to the data shared by the second touch link electronic device to provide the shared data with a property assigned by the permission in the first touch link electronic device.

### BRIEF DESCRIPTION OF THE DRAWINGS

The present invention can be more fully understood by reading the subsequent detailed description and examples with references made to the accompanying drawings, wherein:

FIG. 1 is a schematic diagram of touch transmissions between a first touch panel device and a second touch panel device according to the related art;

FIG. 2 is a logical block diagram of a touch communications system for achieving the touch linksystem between the first touch panel device and the second touch panel device in accordance with the prior art;

FIG. 3 illustrates a first touch panel of the first touch panel device shown in FIG. 1 and a second touch panel of the second touch panel device shown in FIG. 1 according to the related art;

FIG. 4 is a flow chart of the touch link method in accordance with the prior art;

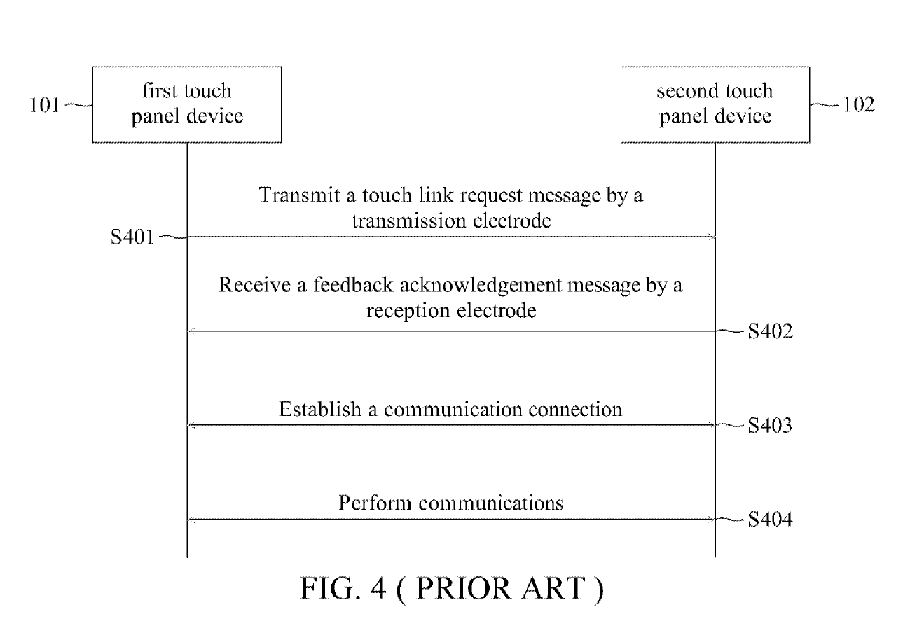

FIG. 5 is a block diagram of a touch link communication system 1;

FIG. 6 is a flowchart of a data sharing method according to an embodiment of the invention;

FIG. 7 is a flowchart of a data management method according to an embodiment of the invention;

FIG. 8 is a flowchart of a data management method according to an embodiment of the invention;

FIG. 9 is a flowchart of a data management method according to an embodiment of the invention;

FIG. 10 is a block diagram of another touch link communication system;

FIG. 11 is a flowchart of a data management method according to an embodiment of the invention;

FIG. 12 is a block diagram of another touch link communication system;

FIG. 13 is a flowchart of a data management method according to an embodiment of the invention;

FIG. 14 is a flowchart of a data management method according to another embodiment of the invention;

FIG. 15 is a flowchart of a data management method according to another embodiment of the invention; and

FIG. 16 is a flowchart of a data management method according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

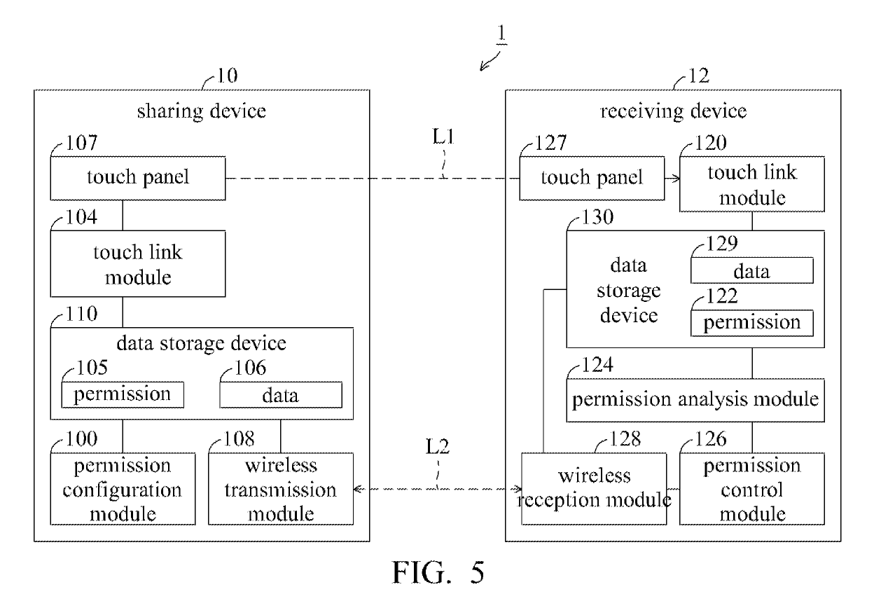

FIG. 5 is a block diagram of a touch link communication system 1. The touch link communication system 1 includes a sharing device 10 and a receiving device 12. The sharing device 10 and receiving device 12 can establish a touch connection L1 with a touch in close proximity. The sharing device 10 and receiving device 12 may be smart watches, smartphones, tablet computers, televisions, printers, smart home appliances, or other devices or apparatuses which are able to establish a touch connection. The touch connection L1 may be implemented by Near Field Communication (NFC), Hot Knot, or other touch link technology, wherein the sharing device 10 and receiving device 12 or multiple touch link electronic devices may establish connections by sensing each other in close proximity. The sharing device 10 and receiving device 12 may be the same or different types of touch link electronic devices. In one embodiment, the sharing device 10 and receiving device 12 both may be smartphones. In another embodiment, the sharing device 10 may be a smartphone while the receiving device 12 may be a tablet computer. The sharing device 10 and receiving device 12 may establish a wireless connection L2 therebetween via other wireless communication technology. For example, the wireless connection L2 may be a Bluetooth connection, WiFi connection, infrared connection, or another non-touch link wireless connection.

When the sharing device 10 shares data or files to the external receiving device 12, it can firstly configure permission of the data or files to be shared, and then transmit the configured permission and shared data or files with the receiving device 12 through a communication connection. Upon receiving the configured permission and shared data or files, the receiving device 12 can record both received information internally. When the shared data or files are required, the receiving device 12 can make the shared data or files valid only via the configured permission, thereby allowing the shared data or files to acquire safety attributes described by the configured permission.

The configured permission may be data containing a safety permission, with the unreproducible, unsharble, and/or uncaptureable properties, rendering invalid after certain operations, period of time, or interactions of other properties, or a combination thereof. For example, the configured permission may be a Digital Rights Management (DRM) file, a safety file dedicated to Hot Knot technology, or a safety file complying with another touch link technology. The shared data or files may be at least a part of file, video file, text file or executable file, and so on. The invalid data or files after certain operations, a period of time, or interactions of other properties may include the shared data or files becoming invalid after they are used for a period of time, a certain number of times, after an absolute time, or after a certain event is triggered. The triggered event may include a communication disconnection between the sharing device 10 and receiving device 12. For example, when the touch connection L1 and/or wireless connection L2 is disconnected, the shared data or files stored in the receiving device 12 become expired, invalid, or useless. In another example, the shared data will become invalid after 30 seconds after receipt of the receiving device 12.

Moreover, the configured permission may be predefined for different types of receiving devices 12, configured or modified during the sharing device 10 and receiving device 12 performing the touch link operation. For example, when the sharing device 10 identifies that the receiving device 12 is a smartphone, a predefined permission 1 is employed for sharing the data and files, and when the sharing device 10 identifies that the receiving device 12 is a tablet computer, a predefined permission 2 is employed for sharing the data and files. In some embodiments, the configured permission may be predefined for different types of shared data or files. For example, when the shared data or files are image files, the sharing device 10 will utilize permission 3 for sharing the data or files. In another example, a predefined permission is provided on the receiving device 12, the receiving device 12 will determine the permission to be used according to the configured permission from the sharing device 10 and the predefined permission on the receiving device 12, and access the shared data or files by the permission to be used.

The receiving device 12 may invalidate the shared data or files by encrypting the shared data or files so that they become undecodable, partially destroying the shared data or files, deleting the shared data or files or performing any operation which causes the shared data or files to no longer be available for use by the sharing device 12.

The access operations of the shared data or files include opening, playing, displaying, executing, or storing the shared data or files. The receiving device 12 can access the shared data or files. In some embodiments, one sharing device 10 may transmit the same or different data or files and the corresponding configured permission to multiple receiving devices 12. In other embodiments, multiple sharing devices 10 may transmit data or files and the corresponding configured permission to one receiving device 12.

The sharing device 10 includes a permission configuration module 100, a data storage device 110, a touch link module 104, a touch panel 107 and a wireless transmission module 108. The storage device 110 stores permission 105 and data 106. When the sharing device 10 intends to share the data 106 to the receiving device 12, the permission configuration module 100 can configure the permission 105 for the data 106, and then the touch link module 104 can transmit the permission 105 to the receiving device 12 via the touch connection L1, which has already been established between the sharing device 10 and receiving device 12 through a touch in close proximity. In some embodiments, the sharing device 10 and receiving device 12 may exchange safety messages via the touch connection L1 to adopt other wireless communication technology (e.g. WiFi, Bluetooth, and so on) for establishing the wireless connection L2, so that the sharing device 10 can transmit the data 106 to the receiving device 12 through the wireless connection L2. In other embodiments, the sharing device 10 and receiving device 12 may establish the wireless connection L2 directly, so that the wireless transmission module 108 of the sharing device 10 can transmit the data 106 to the receiving device 12. Since the distance between the sharing device 10 and the receiving device 12 is short and may be, for example, 5 mm, therefore transmitting the permission 105 via the touch connection L1 can ensure transmission security. On the other hand, since the bandwidth and/or transmission speed via the wireless connection L2 exceeds that of the touch connection L1, it is used to transmit data 106 with a large data size (in comparison to the permission 105), e.g. a large data size may be anything that exceeds 4 KB.

The receiving device 12 includes a touch link module 120, a storage device 130, a touch panel 127, a permission analysis module 124, a permission control module 126 and a wireless reception module 128. The data storage device 130 is configured to store permission 122 and data 129. When the sharing device 10 shares the data 106 with the receiving device 12, the touch link module 120 can receive the permission 105 and the data 106 via the touch connection L1, which has been established between the sharing device 10 and receiving device 12 through the touch in close proximity, and save the permission 105 as the permission 122 in the storage device 130. Then, the wireless connection L2 can be established between the sharing device 10 and receiving device 12, so that the wireless reception module 128 can receive the data 106 from the sharing device 10 via the wireless connection L2, and save the data 106 as the data 129 in the storage device 130.

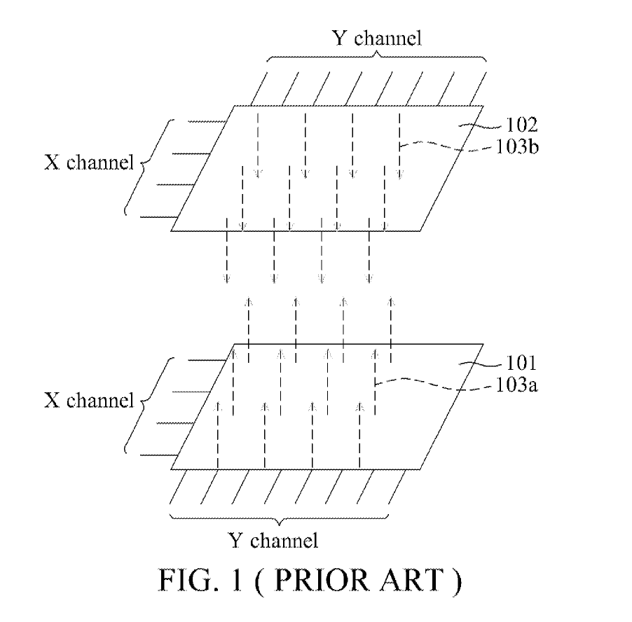

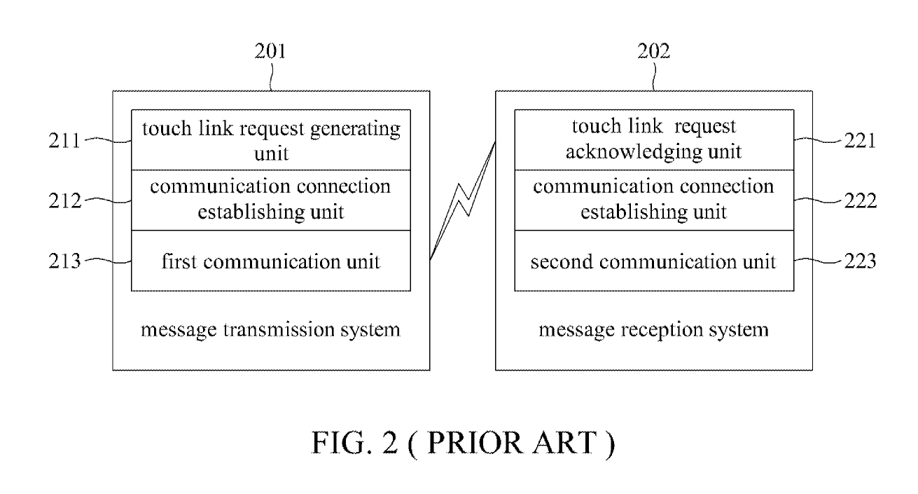

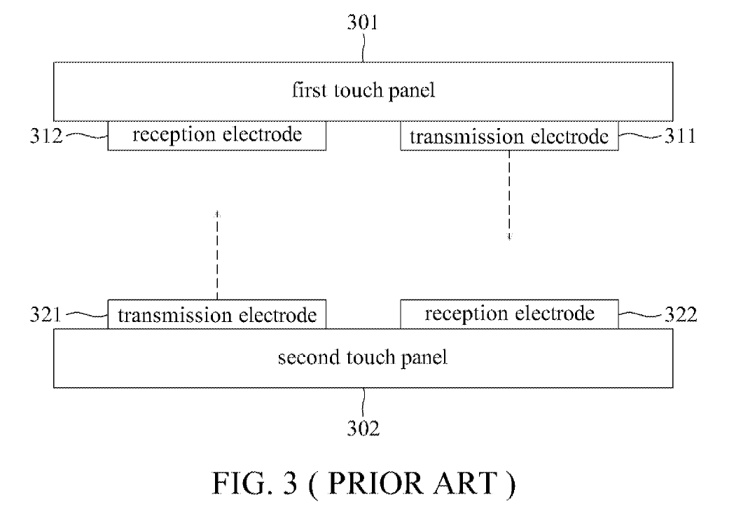

In one embodiment, the touch link module 104 includes a sensing module 1042 and a connection module 1044 (not shown). Likewise, the touch link module 120 includes a sensing module 1202 and a connection module 1204 (not shown), wherein the sensing modules 1042 and 1202 have the same structure and functions, and the connection modules 1044 and 1204 have the same structure and functions. The sharing device 10 and receiving device 12 check whether another device is physically nearby (e.g., in close proximity to or touching). In one example, the sensing module 1042 checks whether the sharing device 10 is in close proximity to another device. Upon detecting that another device is nearby, a first communication channel is established via the wireless module 1044. For instance, the sensing module 1042 senses the electromagnetic field between the sharing device 10 and receiving device 12 (e.g., determining the presence of the electromagnetic field through a sending electrode and a receiving electrode on the touch panel, as indicated in FIG. 3), and determines whether the receiving device 12 is physically nearby according to variations in the electromagnetic field. Once a nearby device is detected, the connection modules 1044 and 1204 will establish the first communication channel. In one embodiment, the connection module 1044 may be the message transmission system as shown in FIG. 2, the connection module 1204 may be the message reception system as shown in FIG. 2, the first communication unit 213 of the touch panel 127 of the sharing device 10 and the second communication unit 223 of the touch panel 127 of the receiving device 12 in FIG. 1 are utilized to establish the first communication channel.

When the receiving device 12 needs to access the data 129 shared by the sharing device 10, the permission analysis module 124 can analyze the permission 122 to identify the validity of accessing the shared data 129. The permission control module 126 is configured to control the access operations of the data 129 based on the analyzed result. When the permission analysis module 124 determines that the shared data 129 is valid, the permission control module 126 can allow the access operations of the shared data 129. Whereas when the permission analysis module 124 determines that the shared data 129 is invalid, the permission control module 126 will forbid the access operations of the shared data 129, and invalidate the shared data 129.

Although FIG. 5 shows embodiments in which the permission and shared data are transmitted via the touch connection L1 and wireless connection L2, respectively, in certain embodiments, the permission and shared data may also be transmitted via only the touch connection L1.

The touch link communication system 1 allows the sharing device 10 to increase shared-data security by configuring permission for protecting shared data.

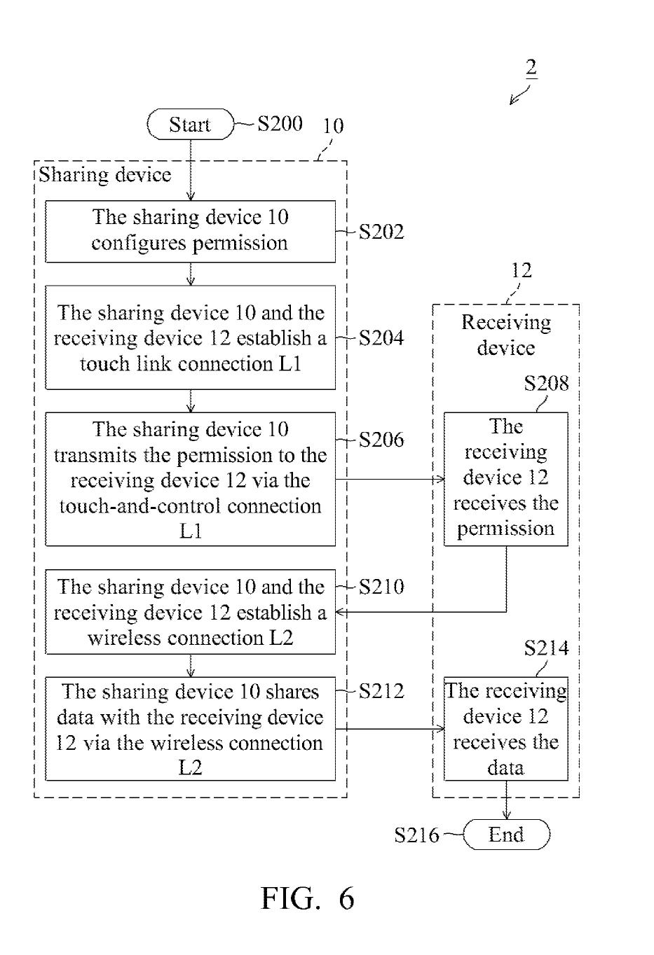

FIG. 6 is a flowchart of a data sharing method 2 according to an embodiment of the invention, adopted by the touch link communication system in FIG. 5.

When the sharing device 10 and receiving device 12 have already established a touch connection L1, and the sharing device 10 is going to share data 106 with the receiving device 12, the sharing device 10 and receiving device 12 start performing the data sharing method 2 (S200). Initially, the sharing device 10 can configure the permission 105 of the shared data 106 according to for example, the type of the receiving device 12, type of the data 106, or user preference (S202). Next, the sharing device 10 can establish the touch connection L1 to the receiving device 12 via a touch in close proximity (S204), and subsequently transmit the permission 105 to the receiving device 12 via the touch link L1 (S206). In response, the receiving device 12 can receive the permission 105 via the touch connection L1 and store it as the permission 122 (S208). The sharing device 10 can then be triggered to establish the new wireless connection L2 to the receiving device 12 using a method that is not the touchlink technology (S210), and subsequently send the shared data 106 to the receiving device 12 via the wireless connection L2 (S212). In response, the receiving device 12 can receive the shared data 106 via the wireless connection L2 and store it as the data 129 (S214). Step S210 is optional, when no wireless connection L2 is established between the sharing device 10 and receiving device 12, the sharing device 10 may transmit the shared data 106 to the receiving device 12 via the touch connection L1, and the receiving device 12 may receive the shared data 106 via the touch connection L1, which is then stored as the data 129 in Step S214. The data sharing method 2 is then completed and exited (S216).

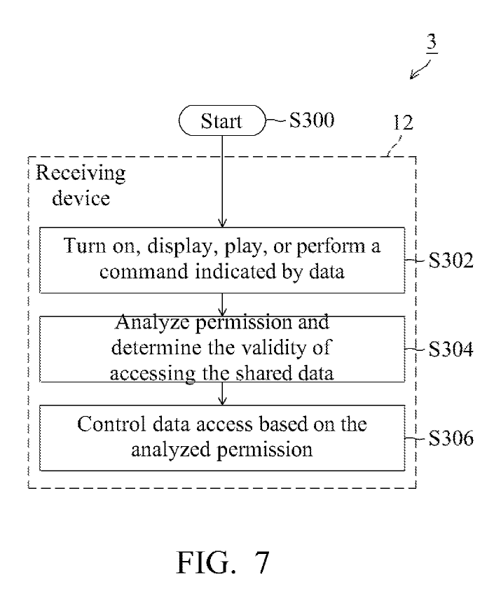

FIG. 7 is a flowchart of a data management method 3 according to an embodiment of the invention, adopted by the receiving device 12 in FIG. 5. The receiving device 12 adopts the data management method 3 to access the data 129 stored on the receiving device 12.

After the data sharing method 2 is completed, the data 129 and the corresponding permission will be available on the receiving device 12. The receiving device 12 adopts the data management method 3 to access the data 129 stored on the receiving device 12 (S300). Firstly, the receiving device 12 can receive an instruction from a user to access the data 129, which includes a command to open, display, play, or execute the data 129 (S302). Upon receiving the instruction, the permission analysis module 124 can analyze the permission 122 and determine the validity of accessing the shared data 129 according to the permission 122 (S304), and subsequently, the permission control module 126 can control the access of the data 129 based on the analyzed permission (S306). For instance, when the permission analysis module 124 determines that the access of the shared data 129 has exceeded the number of times or period of time for accessing the data 129, it will invalidate the access operation of the shared data 129. Consequently, the permission control module 126 is not allowed to access the shared data 129, and invalidate the shared data 129. When the permission analysis module 124 determines that the access of the shared data 129 has not yet exceeded the number of times or period of time for accessing the data 129, it will grant the access operation of the shared data 129. Consequently, the permission control module 126 is allowed to access the shared data 129. The data management method 3 is then completed and exited.

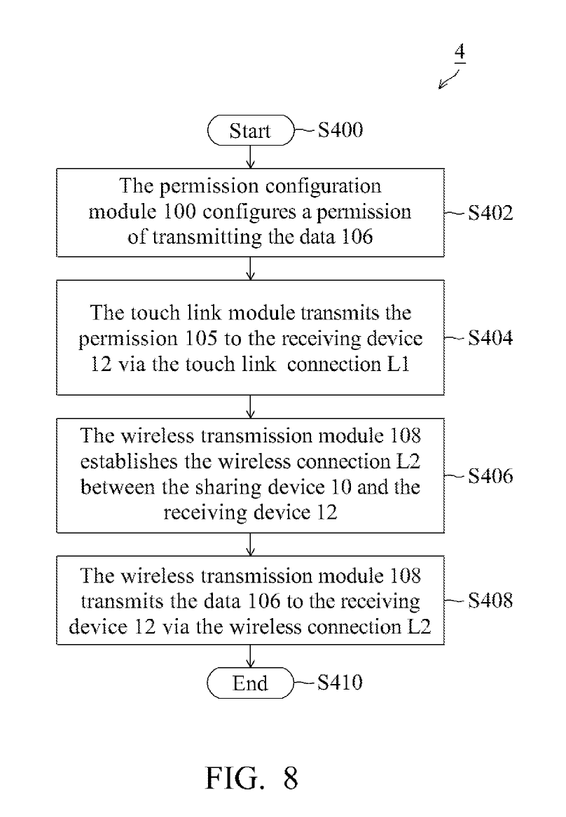

FIG. 8 is a flowchart of a data management method 4 according to an embodiment of the invention, adopted by the touch link communication system 1 in FIG. 5. In particular, data management method 4 is adopted by the sharing device 10 which has already established the touch connection L1 with the receiving device 12 to configure corresponding permission 105 for each shared data 106, and transmit the shared data 106 and a corresponding permission 105 to the receiving device 12 through the wireless connection L2 and the touch connection L1, respectively.

When determining to share the data 106, the sharing device 10 starts performing the data management method 4 (S400). Firstly, the permission configuration module 100 configures a permission 105 of the shared data 106 according to what type of the receiving device 12 is being used, type of data 106, or user preference (S402). The permission 105 may indicate the validity of the shared data 106. For example, the permission 105 indicates that the shared data or files 106 is invalid after certain operations, a period of time, or interactions of other properties, including the shared data or files becomes invalid after using the shared data or files for a period of time, for a number of times, after an absolute time, or after certain event is triggered, wherein the event may be the touch connection L1 and/or wireless connection L2 is disconnected. The permission 105 may also indicate the access property of the shared data. For example, the permission 105 may indicate security information, having the unreproducible, unsharble, and/or uncaptureable properties.

Having the touch link L1 established between the sharing device 10 and receiving device 12, the touch link module 104 can deliver the permission 105 to the receiving device 12 via the touch link L1 (S404). Next, the sharing device 10 and receiving device 12 can establish a new wireless connection L2 triggered by the wireless transmission module 108 (S406), and the wireless transmission module 108 of the sharing device 10 may transmit the shared data 106 to the receiving device 12 via the wireless connection L2 (S408). After transferring the data 106 and corresponding permission to the receiving device 12, the data management method 4 is completed and exited (S410).

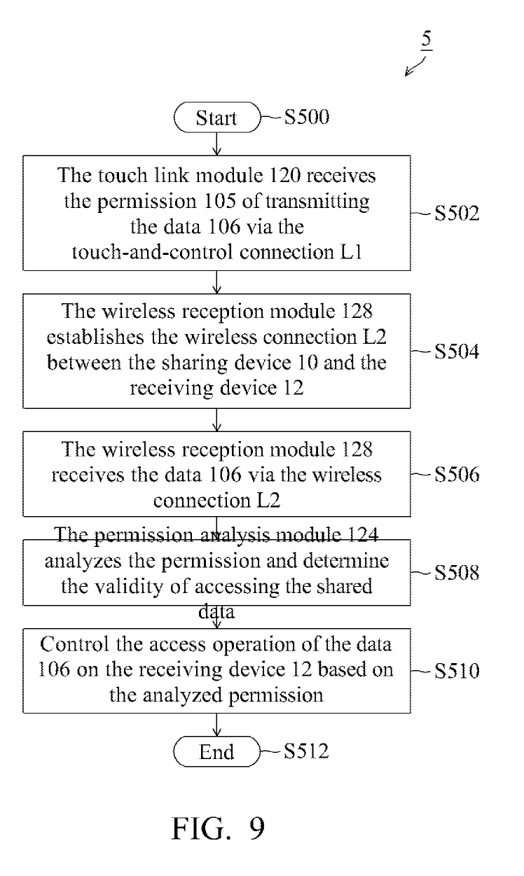

FIG. 9 is a flowchart of a data management method 5 according to an embodiment of the invention, adopted by the touch link communication system in FIG. 5. In particular, the data management method 5 is adopted by the receiving device 12 which has already established the touch connection L1 with the sharing device 10 to receive the corresponding permission for each data 106, wherein the permission 105 defines the validity of the data 106.

When the sharing device 10 and receiving device 12 have already established the touch connection L1, and the receiving device 12 determines to access the data 106 from the sharing device 10, the receiving device 12 starts performing the data sharing method 5 (S500). Firstly, the touch connection module 120 of the receiving device 12 can receive the permission 105 (first permission) of the shared data 106 via the touch connection L1, which is saved as the permission 122 in the local data storage device. Later, the wireless reception module 128 of the receiving device 12 can establish a wireless connection L2 to the sharing device 10 (S504) and receive the shared data 106 via the wireless connection L2 (S506), which is saved as the data 129 in the local data storage device. Once the receiving device 12 obtains an instruction from a user about accessing the data 129, the permission analysis module 124 can analyze the permission 122 and determine the validity of accessing the shared data 129 according to the analyzed permission 122 (S508), and subsequently, the permission control module 126 can control access to the data 129 on the receiving device 12 based on the analyzed permission (S510). For instance, when the permission analysis module 124 determines that the shared data 129 has been accessed more than a certain number of times, or for longer than the allowable period of time for accessing the data 129, it will invalidate the access operation of the shared data 129. Consequently, the permission control module 126 is not allowed to access the shared data 129, and invalidate the shared data 129. When the permission analysis module 124 determines that the access of the shared data 129 has not yet exceeded the number of times or period of time for accessing the data 129, it will grant the access operation of the shared data 129. Consequently, the permission control module 126 is allowed to access the shared data 129. In certain embodiments in Step S508, the receiving device 12 contains a predefined permission (second permission), determine the final permission to be used according to the permission configured by the sharing device 10 and the local predefined permission, and access the data 129 based on the final permission. The data management method 5 is completed and exited (S512).

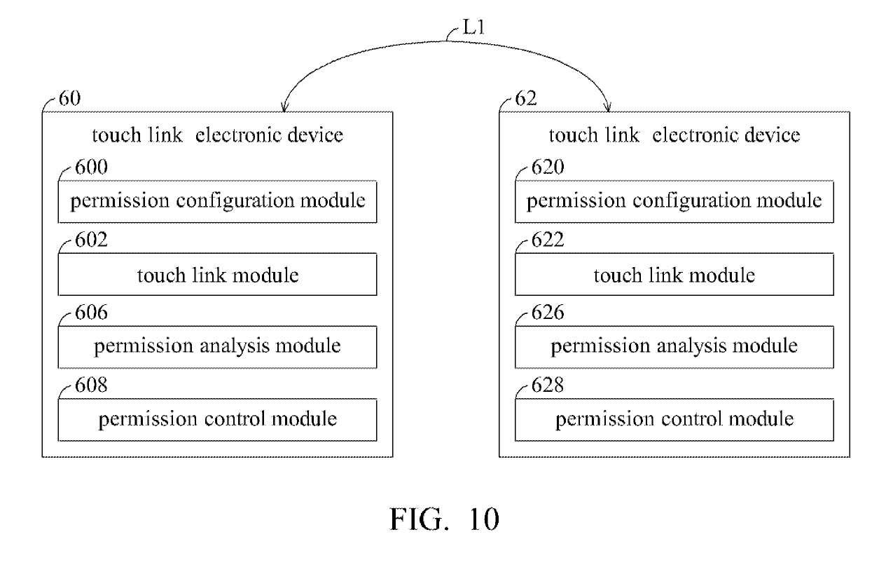

FIG. 10 is a block diagram of another touch link communication system 6, including touch link electronic devices 60 and 62. The touch link electronic devices 60 and 62 may concurrently be sharing devices and receiving devices, thus both include permission configuration modules 600 and 620, touch link modules 602 and 622, permission analysis modules 606 and 626, and permission control modules 608 and 628. Although not shown in FIG. 10, the touch link electronic devices 60 and 62 may further include wireless transmission modules and reception modules for establishing a wireless connection and transmitting or receiving data.

The embodiments in FIGS. 5 and 10 are different in that the touch link electronic devices 60 and 62 are a sharing device as well as a receiving device. The touch link electronic devices 60 and 62 may concurrently share files with one another. Upon sharing files, each touch link electronic device can configure permission for the respective shared file, and send the permission and shared files via the touch connection L1 with the other. The internal circuit configuration and functions of the touch link electronic devices 60 and 62 are identical to those in the sharing device 10 and receiving device 12, the explanation for which has been provided in the preceding paragraphs and will not be repeated here.

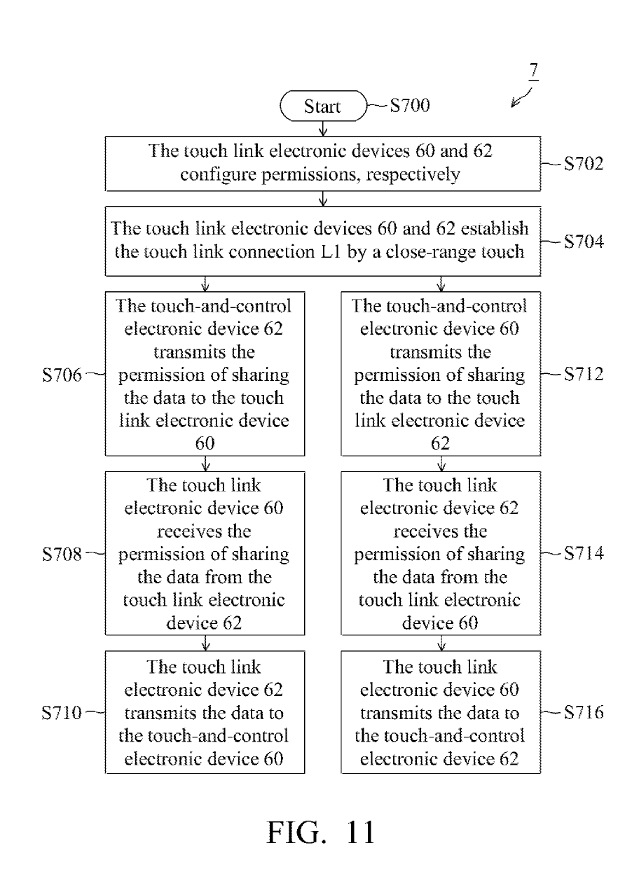

FIG. 11 is a flowchart of a data management method 7 according to an embodiment of the invention, adopted by the touch link communication system 6 in FIG. 10.

The data management method 7 will be performed after the touch link electronic devices 60 and 62 determine to share data with one another (S700). Firstly, the touch link electronic devices 60 and 62 can configure the permission of the shared data according to the type of the other device, type of the shared data, or user preference (S702). Next, the touch link electronic devices 60 and 62 can establish the touch connection L1 via a touch in close proximity (S704). Subsequent Steps S706, S708, S710 and S718 may be operated concurrently and parallel to the Steps S712, S714, S716 and S720, respectively.

To begin with, the touch link electronic devices 60 and 62 can deliver the permission for sharing data to each other via the touch connection L1 (S706, S712). In response, the touch link electronic devices 62 and 60 can receive the permission from each other via the touch connection L1 (S708, S714). Later, the touch link electronic devices 62 and 60 can share the data to each other (S710, S716). Correspondingly, the touch link electronic devices 62 and 60 can receive the shared data from each other via the touch connection L1 (S718, S720). The data management method 7 is then completed and exits.

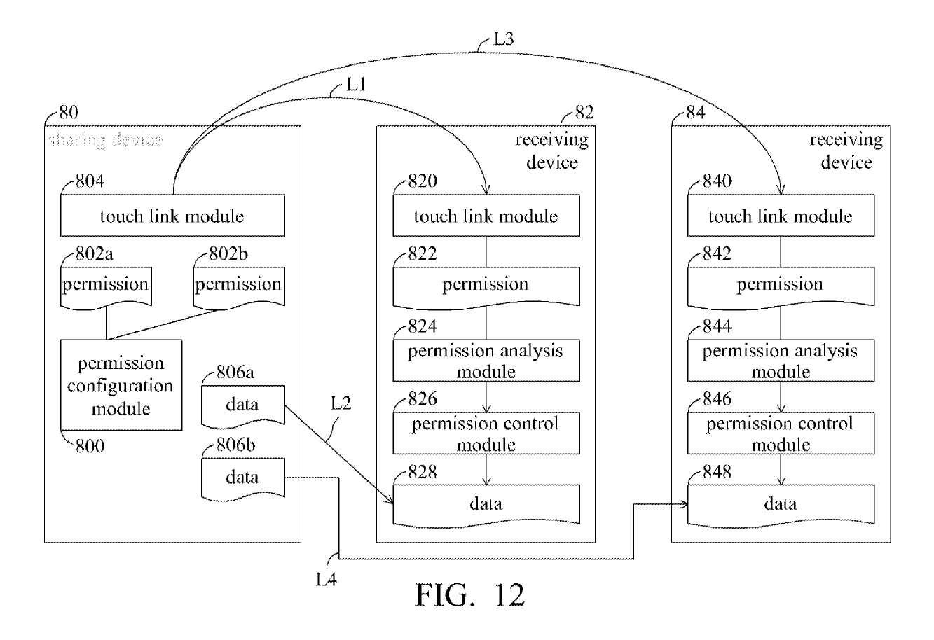

FIG. 12 is a block diagram of another touch link communication system 8, including a sharing device 80 and receiving devices 82 and 84. The circuit configuration of the sharing devices 80 and 10 are identical, and the circuit configuration of the sharing devices 82, 84 and 12 are identical, a description of the circuit configuration and functions has been provided in the preceding paragraphs and will not be repeated here.

FIG. 12 depicts an embodiment of a sharing device sharing data to two receiving devices. The sharing device 80 may establish respective touch connections L1 and L3 and respective wireless connections L2 and L4 to the receiving devices 82 and 84, where the receiving devices 82 and 84 may concurrently or separately touch the sharing device 80 to establish the touch connections L1 and L3 and wireless connections L2 and L4, where the permission are transmitted via the touch connections L1 and L3 and the data are transmitted via the wireless connections L2 and L4. The sharing device 80 wishes to transmit data 806a and 806b to the receiving devices 82 and 84, respectively, and thus it configures permission 802a and 802b corresponding to the data 806a and 806b, respectively. The data 806a and 806b may be the same or different data, and the permission 802a and 802b may be the same or different permissions.

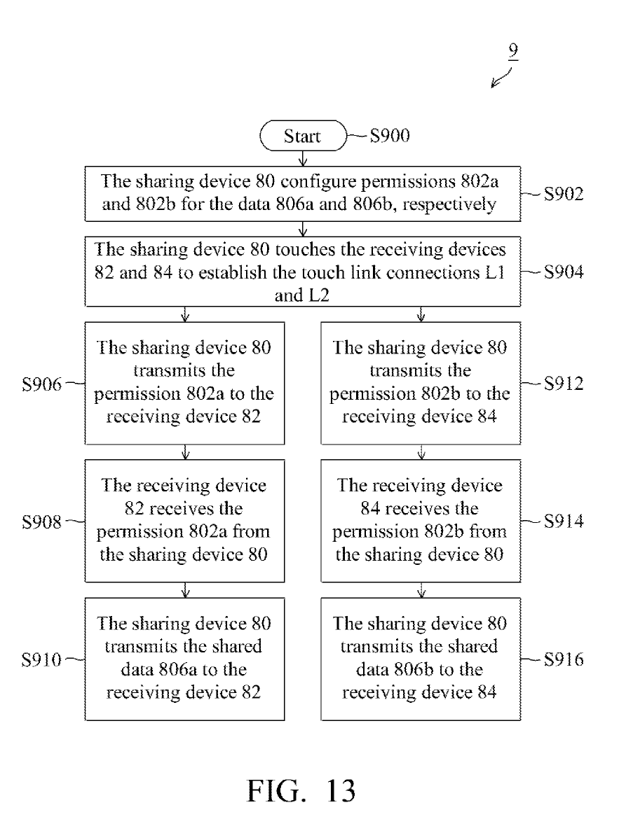

FIG. 13 is a flowchart of a data management method 9 according to an embodiment of the invention, adopted by the touch link communication system 8 in FIG. 12. The data management method 9 shows the procedure that the sharing device 80 concurrently transmits permission and data to the receiving devices 82 and 84.

The data management method 9 will be performed after the sharing device 80 determines to share data to the receiving devices 82 and 84 (S900). Firstly, since the sharing device 80 determines wishes to share the data 806a and 806b with the receiving devices 82 and 84, respectively, the permissions 802a and 802b corresponding to the data 806a and 806b are configured, respectively (S902). It follows that the receiving devices 82 and 84 can concurrently or sequentially touch the sharing device 80 to establish the touch connections L1 and L3.

Subsequent Steps S906, S908, S910 and S918 may be operated concurrently and parallel to the Steps S912, S914, S916 and S920, respectively. To begin with, the sharing device 80 can transmit the permission 802a and 802b to the receiving devices 82 and 84 via the touch connections L1 and L3, respectively (S906, S912). In response, the receiving devices 82 and 84 can respectively receive the permission 802a and 802b from the sharing device 80 via the touch connections L1 and L3 (S908, S914). Later, the receiving devices 82 and 84 may concurrently or separately establish the wireless connections L2 and L4 to the sharing device 80, and the sharing device 80 can share the data with the receiving devices 82 and 84 via the wireless connections L2 and L4 (S910, S916). Correspondingly, the receiving devices 82 and 84 can respectively receive the shared data from the sharing device 80 via the wireless connections L2 and L4 (S918, S920). The data management method 9 is then completed and exits.

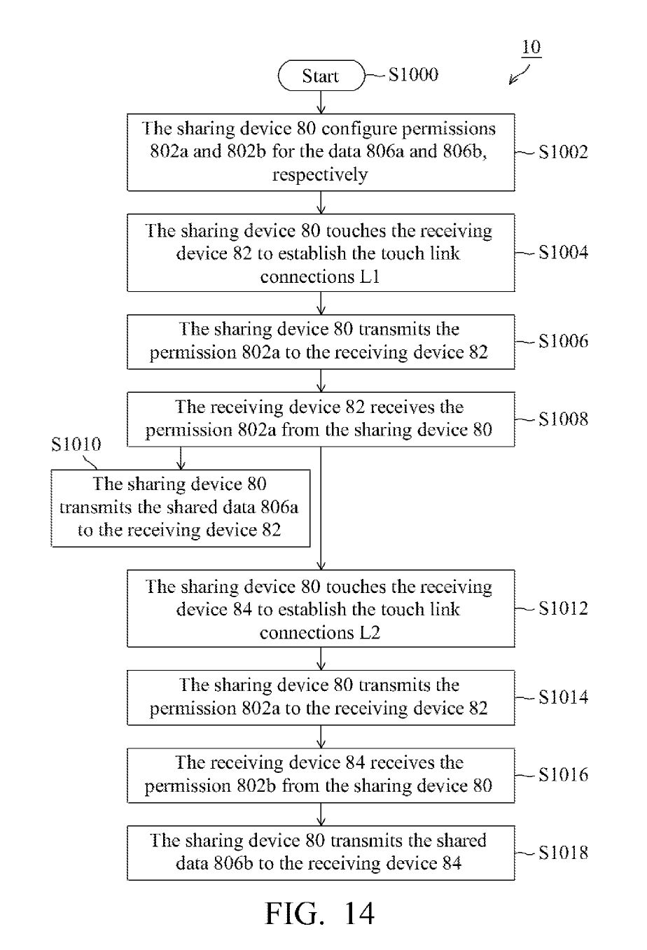

FIG. 14 is a flowchart of a data management method 10 according to another embodiment of the invention, adopted by the touch link communication system 8 in FIG. 12. The data management method 9 shows the procedure that the sharing device 80 sequentially transmits permission and data to the receiving devices 82 and 84.

The embodiments in FIGS. 13 and 14 are different in that Steps S1000 through S1018 are performed sequentially, the sharing device 80 transmits the permission to the receiving device 82 then to the receiving device 84, and sequentially establishes the touch connections L1 and L2 to the receiving devices 82 and 84 (S1004 and S1012). Firstly, because the sharing device 80 has to send the data 806a and 806b to the receiving devices 82 and 84, respectively, thus it can configure the permission 802a and 802b corresponding to the data 806a and 806b, respectively (S1002). Later, the sharing device 80 can establish the touch connection L1 to the receiving device 82 (S1004), and transmit the permission 802a corresponding to the data 806a to the receiving device 82 (S1006). The receiving device 82 can receive the permission 802a corresponding to the data 806a from the sharing device 80 (S1008). Next, the sharing device 80 can establish the wireless connection L3 to the receiving device 82, and transmit the data 806a to the receiving device 82 via the wireless connection L3 (S1010). While transmitting the data 806a, the receiving device 84 can establish the touch connection L2 with the sharing device 80 (S1012). The sharing device 80 can transmit the permission 802b corresponding to the data 806b to the receiving device 82 (S1014), and correspondingly, the receiving device 84 can receive the permission 802b corresponding to the data 806b from the sharing device 80 (S1016). Next, the sharing device 80 can establish the wireless connection L4 to the receiving device 84, and transmit the data 806b to the receiving device 84 via the wireless connection L4 (S1010). The data management method 9 is then completed and exits.

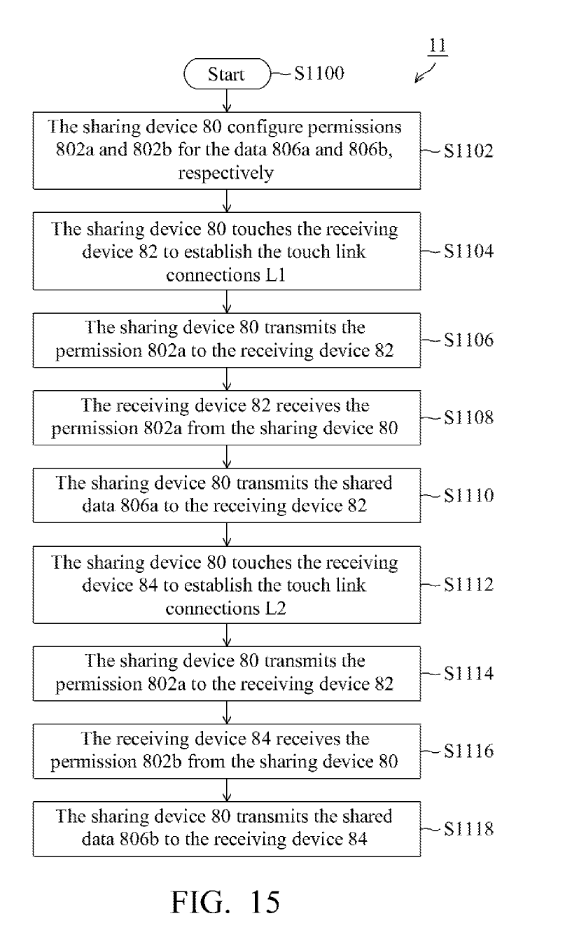

FIG. 15 is a flowchart of a data management method 11 according to another embodiment of the invention, adopted by the touch link communication system 8 in FIG. 12. The data management method 9 shows another procedure in which the sharing device 80 sequentially transmits permission and data to the receiving devices 82 and 84.

Steps in the embodiments in FIGS. 15 and 14 are identical but in a different order. In comparison to Step S1008 through S1012 in FIG. 10, Steps S1108 through S1112 are performed sequentially rather than in parallel. That is, in the data management method 11, after the permission and data are transmitted from the sharing device 80 to the receiving device 82 completely, then the permission and data are transmitted to the receiving device 84. Other Steps in FIG. 15 are identical to those in FIG. 14 and will not be repeated here.

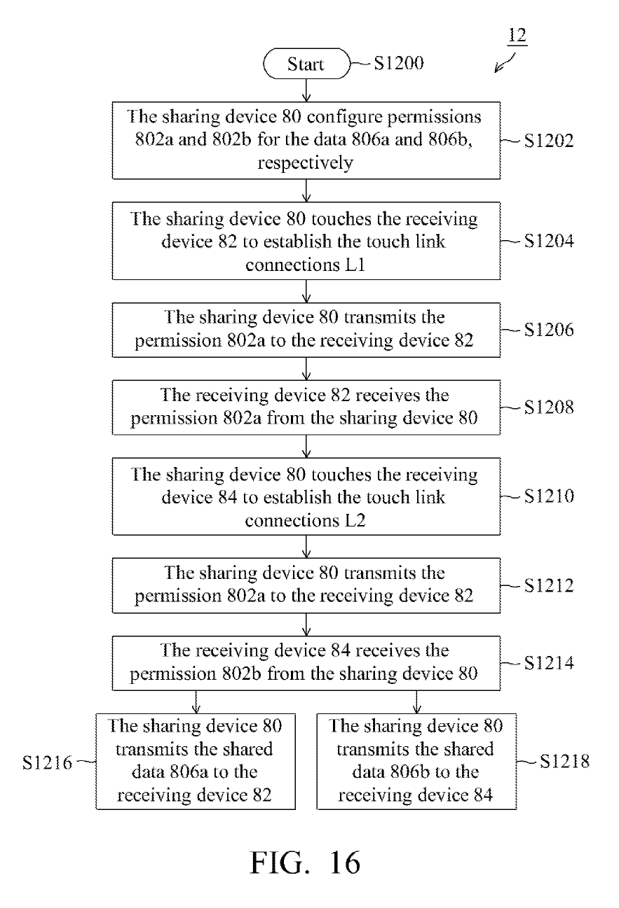

FIG. 16 is a flowchart of a data management method 12 according to another embodiment of the invention, adopted by the touch link communication system 8 in FIG. 12. The data management method 9 shows another procedure that the sharing device 80 sequentially transmits permission and data to the receiving devices 82 and 84.

Steps in the embodiments in FIGS. 16 and 15 are identical but different in order. In comparison to Step S1116 and S1118 in FIG. 15, Steps S1216 and S1218 are performed in parallel rather than sequentially. That is, in the data management method 12, the sharing device 80 transmits the permission firstly to the receiving device 82, then transmits the permission to the receiving device 84. After the transmissions of the permission are completed, the sharing device 80 then transmits the data or applications to the receiving devices 82 and 84. Other Steps in FIG. 16 are identical to those in FIG. 14 and will not be repeated here.

The embodiments in FIG. 5 through 16 allow a sharing device to configure permission, providing protection to the shared data, increasing data security. For example, a copy of the shared data will not be left on the receiving device for a long time by configuring the permission, thereby protecting against theft leaks of secure data due to the user forgetting to remove it, thereby increasing data security.

As used herein, the term “determining” encompasses calculating, computing, processing, deriving, investigating, looking up (e.g., looking up in a table, a database or another data structure), ascertaining and the like. Also, “determining” may include resolving, selecting, choosing, establishing and the like.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or another programmable logic device, discrete gate or transistor logic, discrete hardware components or any combination thereof designed to perform the functions described herein. A general purpose processor may be a microprocessor, but in the alternative, the processor may be any commercially available processor, controller, micro controller or state machine.

The operations and functions of the various logical blocks, modules, and circuits described herein may be implemented in circuit hardware or embedded software codes that can be accessed and executed by a processor.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of configuring permission for shared data, adopted by a first touch link electronic device, the method comprising:
establishing, by a touch panel of the first touch link electronic device, a first communication channel to a second touch link electronic device;
transmitting the permission to the second touch link electronic device via the first communication channel, wherein the permission corresponds to the shared data; and
transmitting the shared data to the second touch link electronic device.

2. The method of claim 1, further comprising:
when detecting that a distance between the first and second touch link electronic devices is less than or equal to 5 millimeters, establishing the first communication channel.

3. The method of claim 1, further comprising:
configuring, by a permission configuration module, the permission.

4. The method of claim 1, wherein the permission indicates validity or an access property of the shared data.

5. The method of claim 1, wherein the permission is associated with a type, a valid time, or a valid number of access times of the shared data, a type of the second touch link electronic device, or an event which is triggered to invalidate the shared data.

6. The method of claim 1, wherein the shared data includes at least a part of a file.

7. A method of configuring permission for shared data, adopted by a first touch link electronic device, the method comprising:
establishing, by a touch panel of the first touch link electronic device, a first communication channel to a second touch link electronic device;
receiving a first permission from the second touch link electronic device via the first communication channel, wherein the first permission corresponds to the shared data transmitted by the second touch link electronic device; and
receiving the shared data.

8. The method of claim 7, further comprising:
when detecting a distance between the first and second touch link electronic devices is less than or equal to 5 millimeters, establishing the first communication channel.

9. The method of claim 7, further comprising:
assigning, by a permission control module, a property of the shared data according to the first permission.

10. The method of claim 9, further comprising:
analyzing, by a permission analyzing module, the first permission;
wherein the step of assigning the property of the shared data according to the first permission comprises: assigning, by the permission control module, the property to the shared data according to the analyzed first permission.

11. The method of claim 10, wherein the step of assigning the property of the shared data comprises: assigning the property to the shared data according to the analyzed first permission and a second permission in the first touch link electronic device.

12. The method of claim 7, further comprising:
when the first permission indicates that the shared data is invalid, an access operation of the shared data is forbidden.

13. The method of claim 7, wherein the first permission indicates validity or an access property of the shared data.

14. The method of claim 7, wherein the first permission is associated with a type of the shared data.

15. A first touch link electronic device, comprising:
a touch panel; and
a touch link module, configured to establish a first communication channel to a second touch link electronic device, and transmit a permission to the second touch link electronic device via the first communication channel;
wherein the permission corresponds to the data shared to the second touch link electronic device to provide the shared data with a property assigned by the permission in the second touch link electronic device.

16. The first touch link electronic device of claim 15, wherein the touch link module further comprises:
a sensing module, configured to determine whether the first touch link electronic device is in close proximity to the second touch link electronic device; and
a connection module, configured to establish the first communication channel via the touch link module when the sensing module determines that they are in close proximity.

17. The first touch link electronic device of claim 16, wherein when a distance between the first and second touch link electronic devices is less than or equal to 5 millimeters, the sensing module is configured to determine that the first touch link electronic device is in close proximity to the second touch link electronic device.

18. The first touch link electronic device of claim 15, further comprises:
a permission configuration module, arranged to configure the permission.

19. The first touch link electronic device of claim 15, wherein the permission indicates validity or an access property the shared data.

20. The first touch link electronic device of claim 15, wherein the permission is associated with a type, a valid time, or a valid number of access times of the shared data, a type of the second touch link electronic device, or an event which is triggered to invalidate the shared data.

21. The first touch link electronic device of claim 15, wherein the shared data includes at least a part of a file.

22. A first touch link electronic device, comprising:
a touch panel; and
a touch link module, configured to establish a first communication channel to a second touch link electronic device, and receive a permission from the second touch link electronic device via the first communication channel;
wherein the permission corresponds to the data shared from the second touch link electronic device to provide the shared data with a property assigned by the permission in the first touch link electronic device.

23. The first touch link electronic device of claim 22, wherein the touch link module further comprises:
a sensing module, configured to determine whether the first touch link electronic device is in close proximity to the second touch link electronic device; and
a connection module, configured to establish the first communication channel via the touch link module when the sensing module determines that they are in close proximity.

24. The first touch link electronic device of claim 23, wherein when a distance between the first and second touch link electronic devices is less than or equal to 5 millimeters, the sensing module is configured to determine that the first touch link electronic device is in close proximity to the second touch link electronic device.

25. The first touch link electronic device of claim 22, further comprising:
a permission control module, arranged to assign a property of the shared data according to the first permission.

26. The first touch link electronic device of claim 25, further comprising:
a permission analyzing module, configured to analyze the first permission;
wherein the permission control module is configured to assign the property to the shared data according to the analyzed first permission.

27. The first touch link electronic device of claim 22, wherein the permission control module is further configured to assign the property to the shared data according to the analyzed first permission and a second permission in the first touch link electronic device.

28. The first touch link electronic device of claim 22, wherein when the first permission indicates that the shared data is invalid, an access operation of the shared data is forbidden.

29. The first touch link electronic device of claim 22, wherein the first permission indicates validity or an access property of the shared data.

30. The first touch link electronic device of claim 22, wherein the first permission is associated with a type of the shared data.
